(19) United States
(12) Patent Application Publication
(10) Pub. No.: US 2007/0110938 A1
(43) Pub. Date: May 17, 2007

(54) Resin tube for automotive piping and method of manufacturing the same

(75) Inventors: Akashi Nakatsu, Nabari-shi (JP); Ryoji Manai, Nabari-shi (JP)

Correspondence Address: DARBY & DARBY P.C., P. O. BOX 5257, NEW YORK, NY, 10150-5257, US

(73) Assignee: Nitta Moore Company, Osaka-shi (JP)

(21) Appl. No.: 11/280,949

(22) Filed: Nov. 15, 2005

(51) Int. Cl. B29C 47/00

(52) U.S. Cl. 428/36.9

(57) ABSTRACT

A resin tube for automotive piping is made of a resin composition containing 6,6-nylon, an impact improver, 6/6,6-copolymer nylon and a plasticizer with a proportion in a mass ratio of the 6,6-nylon:the impact improver:the 6/6,6-copolymer nylon:the plasticizer to be in a range of 100:5-40:5-50:3-20. The resin tube for automotive piping is manufactured by preparing the above resin composition and molding the composition into a tube by extraction. The 6,6-nylon and the impact improver are mixed together in advance and/or the 6/6,6-copolymer nylon and the plasticizer are mixed together in advance.

### TECHNICAL FIELD

This invention relates to a resin tube for automotive piping installed in, for example, an engine compartment and a fuel tank of an automobile, and a method of manufacturing the same.

### DESCRIPTION OF THE RELATED ART

As materials of resin tubes for automotive piping, 11-Nylon and 12-Nylon have high flexibility and toughness, and exhibit excellent secondary processibility in pipe bending processing and the like.

Along with the recent diversification of piping application, it has been demanded that piping is disposed in an engine compartment and a fuel line is built within a fuel tank for the purpose of fuel transparency control.

Since the resin tube disposed in an engine compartment is exposed to an elevated-temperature ambient atmosphere, heat resistance of the tube is required. The resin tube to be arranged within a fuel tank is, after having been disposed therein, exposed to an elevated-temperature ambient atmosphere of about 180° C. during coating and drying process of the tank's exterior, and heat resistance of the tube is also required.

However, resin tube piping using 11-Nylon or 12-Nylon was not sufficient in heat resistance under the above elevated-temperature ambient atmospheres. Moreover, 11-Nylon and 12-Nylon are high cost materials. Under the recent circumstances where severe cost reduction must be achieved, therefore, reconsideration about the material to be used has been required.

The selection of materials which have a high heat resistance and exhibit required performance under an elevated-temperature ambient atmosphere was made. Among the selected materials, 6, 6-Nylon had the problem that stable tube extrusion molding was difficult. On the other hand, the mixture of 6, 6-Nylon and 6-Nylon disclosed in the Japanese Patent Application Laid-Open No. 2003-49976 could be extruded and molded into a tube but the obtained tube immediately after being molded lacks flexibility as a tube, and have difficulty in being cut by on-line cutting with a tube cutting machine on the molding line.

### SUMMARY OF THE INVENTION

It is therefore an object of the present invention to provide a resin tube for automotive piping which exhibits excellent heat resistance, moldability and flexibility, and a method of manufacturing the same.

In order to achieve the object, a resin tube for automotive piping according to the present invention is made of a resin composition containing 6,6-Nylon, an impact improver, 6/6,6-copolymer Nylon and a plasticizer with the proportion in a mass ratio of the 6,6-Nylon:the impact improver the 6/6,6-copolymer Nylon:the plasticizer to be in a range of 100:5-40:5-50:3-20.

The relative viscosity of the above-mentioned 6,6-Nylon measured in a 98% concentrated sulfuric acid solution at 25° C. can be set in a range of 2.0 to 6.0 and the relative viscosity of the above-mentioned 6/6,6-copolymer Nylon measured in a 98% concentrated sulfuric acid solution at 25° C. can be set in a range of 3.0 to 6.0.

The resin tube for automotive piping includes 6, 6-Nylon as its base material and exhibits an excellent heat resistance. Although the extrusion molding is difficult when using 6,6-Nylon alone, addition of impact improver, 6/6,6-copolymer Nylon and plasticizer thereto improves the compatibility of respective resins and enables molding using a common molding apparatus such as an extrusion molding apparatus.

Also, containing 6/6,6-copolymer Nylon in combination with 6,6-Nylon, the molded tube has higher flexibility as compared with the tube of 6,6-Nylon alone. Further, different from 6-Nylon, 6/6,6-copolymer Nylon can provide flexibility to a tube without a plasticizer. Although a relatively flexible tube can be molded using 6/6, 6-copolymer Nylon with no addition of any plasticizer, mixing the plasticizer therein enables to produce more flexible tubes.

As a result, owing to the flexibility of the molded tube, on-line cutting of the tube with a tube cutter in a molding line is possible. Further, the need for pretreatment for making a tube flexible by water absorption or preheating for the purpose of fitting it in a mold at the time of secondary processing such as tube forming is eliminated. The resin composition can be formed into a tube shape by a molding apparatus such as an extrusion molding apparatus and can be further molded and processed into a corrugated shape.

A method of manufacturing the resin tube for automotive piping according to the present invention includes preparing resin composition containing 6,6-Nylon, an impact improver, 6/6,6-copolymer Nylon and a plasticizer with the proportion in a mass ratio of the 6,6-Nylon:the impact improver:the 6/6,6-copolymer Nylon:the plasticizer to be in a range of 100:5-40:5-50:3-20 and molding the resin composition into a tube shape by extrusion molding.

In this method, the above-mentioned resin composition may be prepared by mixing the 6,6-Nylon and the impact improver beforehand and/or mixing the 6/6,6-copolymer Nylon and the plasticizer beforehand.

The resin tube for automotive piping produced by the foregoing method has a high flexibility after molding and, owing to the flexibility, can be cut by on-line cutting with a tube cutter on the molding line. Further, the tube needs no pretreatment to be made flexible by water absorption and preheating for the purpose of being fitted in a mold at the time of secondary processing such as tube forming. The resin composition can be formed into a tube shape by a molding apparatus such as an extrusion molding apparatus and can be further molded and processed into a corrugated shape.

The above-mentioned impact improver is mixed with and dissolved in 6,6-Nylon beforehand and thus the composition increases the viscosity and stable molding is easily made. Since the plasticizer is less compatible with 6,6-Nylon, but highly compatible with 6/6,6-copolymer Nylon, it is in advance mixed with and dissolved in 6/6,6-copolymer Nylon.

Herein, when the addition of the impact improver is less than the above-mentioned range of the ratio, there is the tendency that the material viscosity does not increase and the extruding stability is insufficient. On the other hand, when it is higher than the range of the ratio, there is the tendency that the chemical resistance of a produced tube tends to decrease. When the addition of the 6/6,6-copolymer Nylon is less than the above-mentioned range of the ratio, the flexibility tends to be insufficient, while it is higher than the range, the heat resistance tends to lower, which leads to increase in production cost. When the addition of the plasticizer is less than the above-mentioned range of the ratio, a produced tube tends to be hard (have a problem of flexibility), and when it is higher than the range, the plasticizer tends to bleed from the tube surface.

Examples of the impact improver may include synthetic rubbers such as butadiene type rubber, acrylic graft polymers, chlorinated polyethylene, polyisobutylene, ethylene-vinyl acetate copolymers and methyl methacrylate type copolymers.

Examples of the plasticizer may include sulfonic acid amide derivatives, sulfonic acid ester derivatives, phosphoric acid ester derivatives, phosphazene derivatives, carboxylic acid amide derivatives and carboxylic acid ester derivatives.

For the purpose of imparting various properties to a tube to be produced, additives such as a heat resistance stabilizer, a coloring agent, an antistatic agent, a flame retardant, a reinforcing agent, a processing aid, an antistatic agent, a wear resistance improver, an ultraviolet absorbent, a nucleating agent, a release agent and an oil agent may be added.

In the case the relative viscosity of 6,6-Nylon (according to JIS-K 6920-1 appended document B, 2000, which is also applied to other relative viscosities in this invention) is lower than 2.0 and the relative viscosity of 6/6,6-copolymer Nylon is lower than 3.0, there is the tendency that the fluidity of the resin composition increases at the time of extrusion molding and the composition is extruded unstably. On the contrary, in the case the relative viscosity of 6,6-Nylon exceeds 6.0 and that of 6/6,6-copolymer Nylon exceeds 6.0, there is the tendency that the resin pressure increases too high within an extrusion molding apparatus or a die and the resin is cooled and solidified too readily.

### BRIEF DESCRIPTION OF DRAWING

FIG. 1 is an explanatory drawing of a tube widening tool used in the heat resistance test 2 in Examples.

### DESCRIPTION OF THE PREFERRED EMBODIMENTS

A resin tube for automotive piping of this embodiment is made of a resin composition containing 6,6-Nylon, relative viscosity of which measured in a 98% concentrated sulfuric acid solution at 25° C. is 2.0 to 6.0, an impact improver, 6/6,6-copolymer Nylon, relative viscosity of which measured similarly is 3.0 to 6.0, and a plasticizer with a proportion in a mass ratio of the 6,6-Nylon:the impact improver:the 6/6,6-copolymer Nylon:the plasticizer to be in a range of 100:5-40:5-50:3-20.

Examples of the impact improver include synthetic rubbers such as butadiene type rubber, acrylic graft polymers, chlorinated polyethylene, polyisobutylene, ethylene-vinyl acetate copolymers and methyl methacrylate type copolymers.

Examples of the plasticizer include sulfonic acid amide derivatives, sulfonic acid ester derivatives, phosphoric acid ester derivatives, phosphazene derivatives, carboxylic acid amide derivatives and carboxylic acid ester derivatives.

In order to impart various properties to a tube to be produced, additives such as a heat resistance stabilizer, a coloring agent, an antistatic agent, a flame retardant, a reinforcing agent, a processing aid, an antistatic agent, a wear resistance improver, an ultraviolet absorbent, a nucleating agent, a release agent and an oil agent may be added.

A method of manufacturing a resin tube for automotive piping of the present invention includes mixing 6,6-Nylon, relative viscosity of which measured in a 98% concentrated sulfuric acid solution at 25° C. is 2.0 to 6.0, and an impact improver in advance; mixing 6/6,6-copolymer Nylon, relative viscosity of which measured similarly is 3.0 to 6.0, and a plasticizer in advance; preparing the composition with them with a proportion in a mass ratio of the 6,6-Nylon:the impact improver:the 6/6,6-copolymer Nylon: the plasticizer to be in a range of 100:5-40:5-50:3-20; and molding the resin composition into a tube by extrusion molding.

The features and use of the resin tube for automotive piping of this embodiment and its method of manufacturing the same will be described below.

The resin tube for automotive piping contains 6,6-Nylon as a base material, exhibits an excellent heat resistance, and can be produced and supplied more economically than conventional resin tubes produced with 11-Nylon and 12-Nylon. Although extrusion molding of a tube using 6,6-Nylon alone is difficult, with addition of the impact improver, 6/6,6-copolymer Nylon and the plasticizer thereto, molding a tube using a common molding apparatus such as an extrusion molding apparatus becomes possible.

Further, the extruded tube includes 6/6,6-copolymer Nylon as well as 6,6-Nylon, the flexibility of the tube after molding is higher as compared with that of a tube produced using 6,6-Nylon alone. Furthermore, 6/6,6-copolymer Nylon can impart more flexibility to the tube without a plasticizer as compared with 6,6-Nylon and enables to mold a relatively flexible tube without adding a plasticizer, however the addition of the plasticizer stated above further facilitates production of more flexible tubes.

As a result, owing to the flexibility of the tube, thus produced tube can be cut by on-line cutting with a tube cutter on the molding line. And the tube requires no pretreatment for making a tube flexible by water absorption or preheating before the tube being fit in a mold at the time of the secondary processing such as tube forming. The resin composition can be formed into a tube shape by a molding apparatus such as an extrusion molding apparatus and, if necessary, further be molded and processed into a corrugated shape.

The resin tube for automotive piping produced by the above-mentioned method has high flexibility after molding and the flexibility enables on-line cutting of tubes with a tube cutter on the molding line. Furthermore, this resin tube requires no pretreatment of making a tube flexible by water absorption or preheating in order to fit it in a mold at the time of secondary processing such as tube forming. The resin composition can be formed into a tube by a molding apparatus such as an extrusion molding apparatus and, in addition, can be molded and processed into a corrugated shape.

Also, the above-mentioned impact improver is in advance mixed with and dissolved in the 6,6-Nylon, which advantageously increases the viscosity of the composition and facilitates stable molding. Since the plasticizer is less compatible with 6,6-Nylon, but highly compatible with 6/6,6-copolymer Nylon, the plasticizer is mixed with and dissolved in the 6/6,6-copolymer Nylon in advance.

Herein, when the addition of the impact improver was less than the above-mentioned range of the ratio, the tendency was seen that the material viscosity did not increase and the extruding stability became insufficient. Meanwhile, when it was higher than the range, there was the tendency that the chemical resistance of the produced decreased. When the addition of the 6/6,6-copolymer Nylon was less than the above-mentioned range of the ratio, the flexibility of the material tended to be insufficient, while higher than the range, the heat resistance tended to be lowered, which raises the production cost. When the addition of the plasticizer was less than the above-mentioned range of the ratio, the produced tube tended to be hard (have a problem of flexibility), while when higher than the range, the plasticizer tended to bleed from the tube surface.

In the case the relative viscosity of 6,6-Nylon was lower than 2.0 and that of 6/6,6-copolymer Nylon was lower than 3.0, the fluidity of the composition increased at the time of extrusion molding and the resin composition tended to be extruded unstably. On the contrary, in the case the relative viscosity of 6,6-Nylon exceeded 4.0 and that of 6/6,6-copolymer Nylon exceeded 6.0, the resin pressure within an extrusion molding apparatus or a die increased too high and the resin tended to be cooled and solidified too readily.

As stated above, a resin tube for automotive piping excellent in heat resistance, moldability and flexibility and a method of manufacturing the same can be provided.

### EXAMPLES

Next, the present invention is more specifically described below.

### Example

6,6-Nylon having relative viscosity of 2.9 measured in a 98% concentrated sulfuric acid solution at 25° C. and an impact improver were mixed together in advance. 6/6,6-copolymer Nylon having relative viscosity of 4.4 measured in the same way and a plasticizer were mixed together in advance. The composition was prepared by combining the above with the proportion in a mass ratio of the 6,6-Nylon:the impact improver:the 6/6,6-copolymer Nylon:the plasticizer to be 100:20:40:5. And then the prepared composition was molded into a tube with an outside diameter of 8 mm and an inside diameter of 6 mm by extrusion.

As the mixture of the 6,6-Nylon and the impact improver, Zytel ST801HS manufactured by Du Pont was used. As the mixture of the 6/6,6-copolymer Nylon and the plasticizer, Ube Nylon 5033 JI2 manufactured by Ube Industries, Ltd. was used.

As a result, a tube was stably molded. The molded tube had flexibility immediately after molding and could be cut by on-line cutting with a tube cutter on the molding line.

### Comparative Example 1

Extrusion molding with 6,6-Nylon (Ube Nylon 2033B manufactured by Ube Industries, Ltd.) alone into a tube with 8 mm outside diameter and 6 mm inside diameter 6 mm was attempted. However stable molding of tube failed.

### Comparative Example 2

6,6-Nylon having relative viscosity of 4.2 measured in a 98% concentrated sulfuric acid solution at 25° C. was prepared. Already mixed composition of 6/6, 6-copolymer Nylon having relative viscosity of 4.4 measured in the same way and a plasticizer was prepared. The resin composition was prepared by mixing the above with the proportion in a mass ratio of the 6,6-Nylon:the 6/6,6-copolymer Nylon:the plasticizer to be 100:20:5. The obtained resin composition was molded into a tube with an 8 mm outside diameter and a 6 mm inside diameter by extrusion.

As the 6,6-Nylon, Ube Nylon 2033B manufactured by Ube Industries, Ltd. was used. As the mixture of the 6/6,6-copolymer Nylon and the plasticizer, Ube Nylon 5033 J12 manufactured by Ube Industries, Ltd. was used. No impact improver was added.

As a result, a tube was stably molded, however the molded tube was rigid and hard immediately after molding. When the tube was cut by a tube cutter on the molding line, the cut face was not clear and the on-line cutting was difficult.

The following test was conducting using the tube of the above-mentioned Example, the tube of Comparative Example 2, and a conventional tube as Comparative Example 3 which was made of Nylon 11 and had an outside diameter of 8 mm and an inside diameter of 6 mm. [Heat resistance test 1]

After the respective tubes being fitted in 90 degree bending dies were left in a gear oven at 180° C. for 30 minutes, they were cooled in cooling water. Visual observation was conducted as to the appearances of the respected tubes in a bent posture to find whether any trace of loosening or deforming change is seen. No particular change was visually recognized as to the tubes of Example and Comparative Example 2. On the other hand, as to the tube of Comparative Example 3, the tendency that deformation (being flatter) became significant at the bent part was recognized.

[Heat resistance test 2]

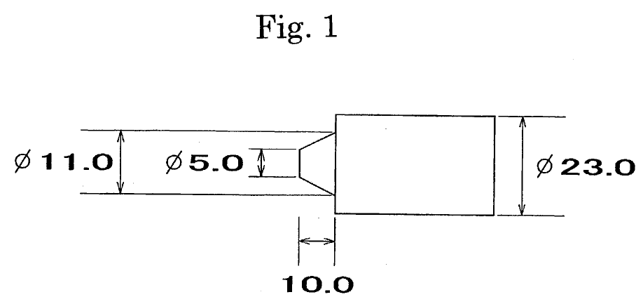

After a number of the respective tubes (N number=20) were left in an atmosphere at 180° C. for one hour, they were put back to an atmosphere of a room air temperature (23±2° C.). Thereafter the respective tube end parts were widened by a tube widening tool shown in FIG. 1 and visual observation was conducted whether there was any cracking. The tubes of Example and Comparative Example 3 (N number=20) were found having no change. On the other hand, two out of the twenty tubes of Comparative Example 2 were found having cracks.

[Heat resistance test 3]

After a number of the respective tubes (N number=20) were left in an atmosphere at 180° C. for one hour, they were respectively cut into 25 mm length, put between two flat plates and pressed perpendicular to the respective tube axes until the inside diameter reduced to 50% thereof, and then visual observation was conducted to find whether there was any change. No change was visually recognized as to the tubes of Example and Comparative Example 3 (N number=20). On the other hand, cracks were recognized on three out of the twenty tubes of Comparative Example 2.

[Burst test]

The respective tubes were subjected to a pressure test with water by increasing the pressure at the pressure-up rate of 7.0 MPa/min until the tubes burst and the maximum pressure values were measured as burst pressures (JASO M319). The tube of Example had a burst pressure of 8.7 MPa, while the tubes of Comparative Example 2 and Comparative Example 3 respectively had 13.4 MPa and 8.0 Mpa. That is, the tube of Example had approximately the same burst pressure as that of the conventional tube (Comparative Example 3) made of Nylon 11. Furthermore, the tube of Example had approximately the same strength and flexibility as that of the conventional tube (Comparative Example 3) made of Nylon 11.

The results of the above-described respective tests are shown in the following Table 1.

TABLE 1

| | | | Heat | Heat | |
|---|---|---|---|---|---|
| | | | resistance | resistance | |
| | | | test 2 | test 3 | |
| | | | (number of | (number of | |
| | | Heat | cracked | cracked | Burst |
| | | resistance | tubes/n | tubes/n | test |
| | Composition | test 1 | number) | number) | (MPa) |
| Example | 6,6-Nylon + impact | No | 0/20 | 0/20 | 8.7 |
| | improver | problematic | | | |
| | 6/6,6-copolymer | change | | | |
| | Nylon + plasticizer | | | | |
| Comparative | 6,6-Nylon | No | 2/20 | 3/20 | 13.4 |
| Example 2 | 6/6,6-copolymer | problematic | Cracks | Cracks | |
| | Nylon + plasticizer | change | were | were | |
| | | | recognized | recognized | |
| Comparative | Nylon 11 | Significant | 0/20 | /20 | 8.0 |
| Example 3 | | deformation | | | |
| | | at the bent | | | |
| | | part | | | |

Being constructed as stated above, the present invention provides resin tubes excellent in heat resistance, moldability and flexibility, and a method of manufacturing such tubes. Because of the excellent heat resistance, moldability and flexibility of the tubes, the tubes of the present invention have a variety of applications for such as resin tubes for automotive piping.

What is claimed is:

1. A resin tube for automotive piping made of a resin composition comprising 6,6-Nylon, an impact improver, 6/6,6-copolymer Nylon and a plasticizer with a proportion in a mass ratio of the 6,6-Nylon:the impact improver: the 6/6,6-copolymer Nylon:the plasticizer to be in a range of 100:5-40: 5-50:3-20.

2. The resin tube for automotive piping according to claim 1, wherein the 6,6-Nylon has relative viscosity in a range of 2.0 to 6.0 measured in a 98% concentrated sulfuric acid solution at 25° C. and the 6/6,6-copolymer Nylon has relative viscosity in a range of 3.0 to 6.0 measured in a 98% concentrated sulfuric acid solution at 25° C.

3. The resin tube for automotive piping according to claim 1, wherein at least a part of the tube is molded and processed into a corrugated shape.

4. The resin tube for automotive piping according to claim 2, wherein at least a part of the tube is molded and processed into a corrugated shape.

5. A method of manufacturing the resin tube for automotive piping according to claim 1, comprising preparing a resin composition by mixing 6,6-Nylon, an impact improver, 6/6,6-copolymer Nylon and a plasticizer with a proportion in a mass ratio of the 6,6-Nylon:the impact improver:the 6/6,6-copolymer Nylon:the plasticizer to be in a range of 100:5-40:5-50:3-20, and molding the resin composition into a tube by extrusion.

6. The method of manufacturing the resin tube for automotive piping according to claim 5, wherein the 6,6-Nylon and the impact improver are mixed together in advance.

7. The method of manufacturing the resin tube for automotive piping according to claim 5, wherein the 6/6,6-copolymer Nylon and the plasticizer are mixed together in advance.

8. The method of manufacturing the resin tube for automotive piping according to claim 5, wherein the 6,6-Nylon and the impact improver are mixed together in advance, and the 6/6,6-copolymer Nylon and the plasticizer are mixed together in advance.

9. The method of manufacturing the resin tube for automotive piping according to claim 5, further comprising molding and processing at least a part of the tube into a corrugated shape.

10. The method of manufacturing the resin tube for automotive piping according to claim 6, further comprising molding and processing at least a part of the tube into a corrugated shape.

11. The method of manufacturing the resin tube for automotive piping according to claim 7, further comprising molding and processing at least a part of the tube into a corrugated shape.

12. The method of manufacturing the resin tube for automotive piping according to claim 8, further comprising molding and processing at least a part of the tube into a corrugated shape.
